(19) United States
(12) Patent Application Publication
(10) Pub. No.: US 2021/0390645 A1
(43) Pub. Date: Dec. 16, 2021

(54) Offline License Distribution Device

(71) Applicant: OSAAP America, LLC, Chelmsford, MA (US)

(72) Inventor: Scott Kohlstrom, Holden, MA (US)

(21) Appl. No.: 16/902,520

(22) Filed: Jun. 16, 2020

(51) Int. Cl. G06Q 50/18; G06Q 30/00; G06Q 50/04; G06F 21/10; G06F 21/12; G06F 21/64; G06F 21/60

(52) U.S. Cl. CPC G06Q 50/184; G06Q 30/0185; G06Q 50/04; G06F 21/105; G06F 21/12; G06F 3/0481; G06F 21/602; G06Q 2220/18; G06Q 2220/165; G06F 2221/0768; G06F 21/64

(57) ABSTRACT

According some aspects, a user may purchase licenses from a vendor and receive a first code that was generated by a license management device and indicates a first quantity of licenses. The user may manually enter the first code into a license distribution device, which may be a handheld device with no connections to the license management device or a licensee device, in order to replenish licenses on the license distribution device. A user may attempt to perform a task that requires one or more licenses on a licensee device. The user may obtain a second code from the licensee device and manually enter the code into the license distribution device. The user may obtain a third code from the license distribution device and manually enter the third code into the licensee device to perform the task for which licenses were sought.

### FIELD OF USE

Aspects of the disclosure relate generally to computer software and computer-aided design and manufacturing applications. More specifically, aspects of the disclosure provide methods and techniques for users of computer-aided design and manufacturing applications to obtain licenses.

### BACKGROUND

Hardware tools and other components are an essential part of many trades. Organizing a set of tools can be important in many industries. For example, computer-aided design and manufacturing (CAD/CAM) software may be used to design and manufacture foam inlays (also referred to as “shadow boards”) for storing a hardware tool set. The vendor of such software may choose to charge its customer by the number of products that are actually manufactured through the software. Thus, the vendor may wish to sell individual licenses (e.g., software licenses) to its end users and keep track of the use of these licenses.

The licenses may be distributed to a remotely located machine via network communications such as the Internet. In other words, the vendor's server that issues licenses and the end user's device that consumes the licenses may need to be able to communicate with each other through a network. However, this solution may not be feasible in an environment where a high level of security is maintained and communications to an outside network is limited or restricted. For example, the defense industry and the government intelligence community may have stricter standards for allowing their devices to communicate with a non-secure device. This may make the distribution of licenses difficult or impossible. Aspects described herein may address these and other problems, and generally improve the ease, efficiency, and speed of license distribution especially in an offline or isolated environment.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. A license distribution device may be communicatively disconnected from a license manager device and a licensee device. In other words, there may not be any wired or wireless communication channel available to the license distribution device with the license manager device or the licensee device. A user may purchase one or more licenses from the operator of the license manager device enter a first code into the license distribution device. The user may obtain a second code from the licensee device in order to perform a task for which one or more licenses are required. The user may enter the second code into the license distribution device and obtain a third code from the license distribution device. The user may enter the third code into the licensee device to perform the task.

Aspects discussed herein may relate to methods and techniques for distributing licenses. A license distribution device may receive a first code from a user where the first code that includes a validation code and an indication of a first quantity of licenses. The first code may be generated by a license manager device. The license distribution device may be communicatively disconnected form the license manager device when the first code is received by the license distribution device. The license distribution device may increase a license counter by the first quantity of licenses based on a determination that the validation code in the first code matches a predetermined validation code stored in the license distribution device. The user may acquire a second code generated by a licensee device and enter the second code into the license distribution device. Alternatively, the second code may be sent by the licensee device to the license distribution device via a communication channel. The second code may include a request for a second quantity of licenses. The license distribution device may generate a third code indicating the second quantity of licenses. The license counter of the license distribution device may be decreased by the second quantity of licenses. The license distribution device may cause output of the third code. The third code may be operable to enable the licensee device to prepare one or more products corresponding to the second quantity of licenses. In some embodiments, such as where the license distribution device and the licensee device are not in electronic communication (e.g., where they are “air gapped”), the user may input the third code into the licensee device. Alternatively, the third code may be sent by the license distribution device to the licensee device via a communication channel, in implementations where the license distribution device and the licensee device are in electronic communication.

In some implementations, the generation of the third code and the decreasing of the license counter may be performed atomically.

In some implementations, the license distribution device may include a display, and the third code may be displayed on the display of the license distribution device.

In some implementations, the second code may include an identifier associated with the licensee device. The third code may be generated based on the identifier.

In some implementations, the second code may be generated and encrypted by the licensee device. The license distribution device may be communicatively disconnected from the licensee device while the license distribution device receives the second code.

Corresponding apparatus, systems, and computer-readable media are also within the scope of the disclosure. These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example license management system, including a license manager device, a license distribution device, and a licensee device that may be used in implementing one or more aspects of the disclosure in accordance with one or more illustrative aspects discussed herein;

FIG. 3A depicts an example code that is generated in a license management system and used in implementing one or more aspects of the disclosure in accordance with one or more illustrative aspects discussed herein;

FIG. 3B depicts an example encryption table entry used in implementing one or more aspects of the disclosure in accordance with one or more illustrative aspects discussed herein; and

FIG. 4 depicts an example system flow diagram that illustrates a method of distributing one or more license tokens without the use of a network in accordance with one or more illustrative aspects discussed herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

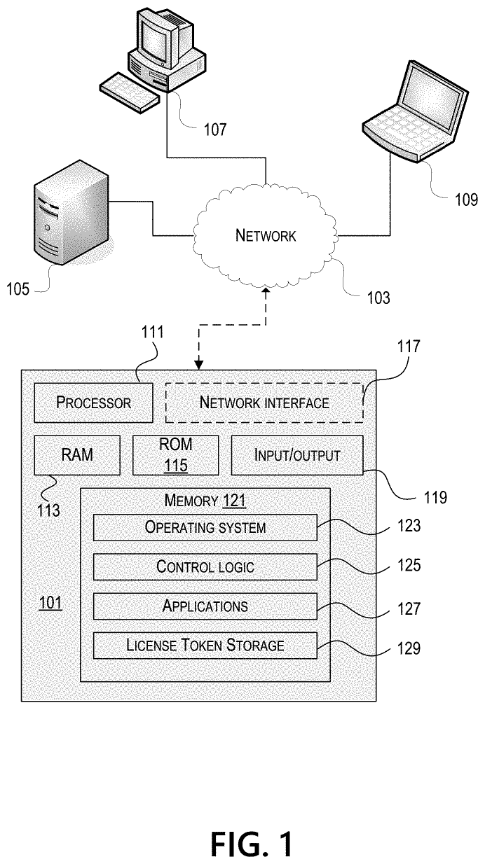

By way of introduction, aspects discussed herein may relate to methods and techniques for distribution of licenses especially in an offline environment. Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device. Computing device 101 may include more components or fewer components than what is described in FIG. 1.

Computing device 101 may, in some embodiments, operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

In some embodiments, as in the case of a license distribution device, computing device 101 may operate in a standalone environment. In other words, computing device 101 may not be connected to any other devices or any networks including the various types of networks described above. Thus, computing device 101 may not have any wired or wireless communication channels established with any other devices. In such embodiments, network interface 117 may be disabled or computing device 101 may lack network interface 117 entirely.

As seen in FIG. 1, computing device 101 may include a processor 111, random access memory (RAM) 113, read-only memory (ROM) 115, network interface 117, input/output interfaces 119, and memory 121. I/O 119 may include a variety of interface units and drives for reading, writing, displaying, and/or printing data or files. For example, input/output interfaces 119 may include one or more of a keyboard, a mouse, a keypad, a touchscreen, a touchpad, a button, a microphone, a display, a printer, a speaker, etc. Input/output interfaces 119 may be integrated into computing device 101 or may be an external device that is connected to computing device 101 through a wired connection or wirelessly. Computing device 101 may be powered by a power grid and/or a battery.

Memory 121 may store software for configuring computing device 101 into a special purpose computing device in order to perform one or more of the various functions discussed herein. Memory 121 may be permanent or semi-permanent storage such as a hard disk drive (HDD), flash memory, a solid-state drive (SSD), an optical drive (e.g., a compact disc read-only memory (CD-ROM) drive, a digital versatile drive read-only memory (DVD-ROM) drive, a Blu-ray Drive, etc.), etc. Memory 121 may store operating system software 123 for controlling overall operation of computing device 101, control logic 125 for instructing computing device 101 to perform aspects discussed herein, one or more applications 127, and license token storage 129. Applications 127 may include computer-aided design (CAD) application. License token storage 129 may be a database. License token storage 129 may store a license token counter and/or license tokens. Computing device 101 may include two or more of any and/or all of these components (e.g., two or more processors, two or more memories, etc.) and/or other components and/or subsystems not illustrated here. All of the components illustrated in FIG. 1 are optional and computing devices 101, in some embodiments, may lack one or more of the components illustrated in FIG. 1.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) Hypertext Markup Language (HTML) or Extensible Markup Language (XML). The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Having discussed several examples of computing devices which may be used to implement some aspects as discussed further below, discussion will now turn to a method for offline distribution of license tokens.

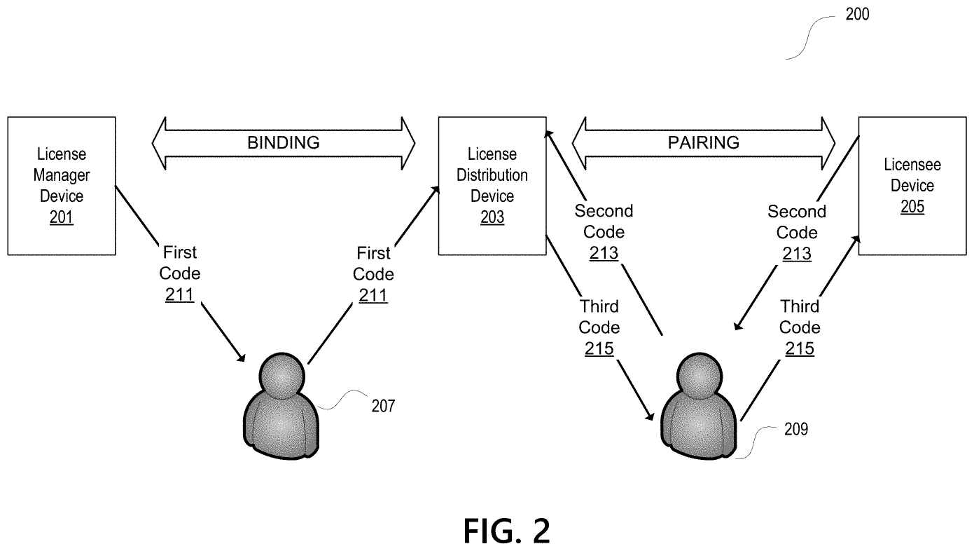

FIG. 2 depicts an example license management system, including a license manager device, a license distribution device, and a licensee device that may be used in implementing one or more aspects of the disclosure. License management system 200 may include license manager device 201, license distribution device 203, and licensee device 205. Each of license manager device 201, license distribution device 203, and licensee device 205 may be implemented with software and/or hardware such as computing device 101 of FIG. 1. License manager device 201, license distribution device 203, and license device 205 may be operated by one or more users such as license purchaser 207 and operator 209. License manager device 201 may issue one or more licenses to licensee device 205 via license distribution device 203. Licensee device 205 may require one or more licenses for partial or full operation. For example, without sufficient quantity of licenses, licensee device 205 may be unable (e.g., locked out) to perform one or more functions or may lose its functionality entirely. The licenses may be consumable. For example, licensee device 205 may be a device that utilizes computer-aided design (CAD) and/or computer-aided manufacturing (CAM) to manufacture a product (e.g., a foam inlay, also known as a shadow board, for organizing a hardware toolset). In this example, licensee device 205 may require one license to produce one manufactured item. The licenses may have an expiration date, after which licensee device 205 can no longer perform its intended function. Thus, in order for licensee device 205 to continue to function, operator 209 may need to replenish licenses issued by license manager device 201. A license may be represented by or embodied in a code, a token, a key, etc.

License manager device 201, license distribution device 203, and licensee device 205 need not be communicatively connected with each other. For example, license distribution device 203 may not be connected to any communication network (e.g., LAN, a cellular network, Bluetooth, Zigbee, Wi-Fi, the Internet, etc.) and thus may be incapable of communicating with license manager device 201 or licensee device 205 via wired or wireless communication. Similarly, licensee device may not be communicatively connected to license manager device 201 and/or license distribution device 203, and may be incapable of communicating with license manager device 201 and/or license distribution device 203 via wired or wireless communication. For example, licensee device 205 may be located in a high-security location (e.g., a government agency, a military facility, etc.) where “air gapping” (i.e., a network security measure employed to ensure that its network is physically isolated from unsecured networks) is mandated. Thus, in such an environment, licensee device 205 may not be able to obtain licenses from license manager device by means of direct electronic communication.

License manager device 201 may be software and/or hardware (e.g., BluePOD License Manager developed by OSAAP America of Chelmsford, Mass.) that is operated by a license issuer such as a manufacturer and/or vendor of licensee device 205. License manager device 201 may be one or more servers. License manager device 201 may create, issue, monitor, and/or deprecate licenses associated with one or more licensee devices such as licensee device 205. License manager device 201 may also set one or more expiration dates on the issued license(s). License purchaser 207 may obtain (e.g., purchase) one or more licenses from license manager device 201. The one or more licenses may be embedded in first code 211. A code (e.g., first code 211, second code 213, third code 215, etc.) may also be referred to as a token, a key, a token code, etc. The obtaining of first code 211 may be automated (e.g., license purchaser 207 may obtain the license(s) from license manager device 201 without additional human intervention) or alternatively license manager device 201 may be operated by a human operator and license purchaser 207 may obtain first code 211 from the human operator of license manager device 201. For example, license purchaser 207, who wishes to purchase bulk licenses to operate licensee device 205 may contact a license issuer (e.g., an enterprise that owns and/or control license manager device 201) by phone, email, letter, website, etc. and request a specific amount of licenses. Optionally, license manager device 201 may verify that payment for the license(s) has been made by license purchaser 207 before issuing first code 211. License manager device 201 may generate and issue first code 211 by displaying first code 211 on a display device. License purchaser 207 may obtain first code 211 by reading first cod 211 off the display device. License purchaser 207 may also obtain first code 211 by phone, email, letter, web site, etc. First code 211 may be human-readable alphanumeric string of text. For example, first code 211 may comprise decimal numbers, hexadecimal numbers, and/or letters. First code 211 may be encoded by license manager device 201 to prevent unauthorized use or counterfeiting. First code 211 may include information, which may be encoded, that indicates an index (e.g., a finder code), an identifier (e.g., a binding code, a device identifier, etc.), a quantity of license(s), an expiration date, an error detection code, etc. Each request to purchase additional licenses may result in a different unique code in order to prevent reuse of a code.

License distribution device 203 may be a device capable of storing licenses, receiving request for licenses, and distributing licenses. License distribution device 203 may be a mobile device such as a handheld device (e.g., BluePOD developed by OSAAP America of Chelmsford, Mass.). License distribution device 203 may be a battery-powered device. License distribution device 203 may be air gapped from license manager device 201 and licensee device 205, that is license distribution device 203 may be communicatively isolated (e.g., disconnected) from license manager device 201 and licensee device 205. Alternatively, a communication channel (e.g., LAN, Internet, Wi-Fi, Bluetooth, Universal Serial Bus (USB), Zigbee, Infrared Data Association (IrDA), cellular network, IEEE 1394, etc.) may be established between license distribution device 203 and licensee device 205. License distribution device 203 may comprise a user input interface (e.g., a keyboard, a keypad, a touchpad, a touchscreen, a button, a microphone, etc.) for entering codes such as first code 211 and second code 213. License distribution device 203 may comprise an output interface such as a display, a printer, a speaker, etc.

License distribution device 203 may have a unique binding code assigned that is used to validate communications between license manager device 201 and license distribution device 203. A binding code may provide the validation means to add licenses and communicate other support requests. In order for license distribution device 203 to accept licenses from license manager device 201, license distribution device 203 may require binding with license manager device 201 first. For example, binding may involve registration (e.g., license distribution device 203 registering its identifier such as a serial number with license manager device 201) and/or sharing of a binding code that links license distribution device 203 to license manager device 201. The binding code may be entered into license distribution device 203 at the time of the binding, or it may be preloaded onto license distribution device 203 prior to deployment (e.g., when license distribution device 203 is manufactured).

License distribution device 203 may also be paired with licensee device 205. For example, license distribution device 203 may be uniquely paired with one licensee device 205 and one device only. License distribution device 203 and licensee device 205 may not be permitted to transfer licenses until the two have been paired. The pairing may be based on the binding code of license distribution device 203. A unique pairing code may be created and shared between license distribution device 203 and licensee device 205. The binding and pairing codes may provide protection against unauthorized use, attempts to copy and reuse codes, and theft of license distribution device 203. A unique pairing reset token (also referred to as an un-pairing token) may be required to allow license distribution device 203 to be paired with a new licensee device. The pairing reset token may be issued by license manager device 201 and be only valid for a one-time use.

After license purchaser 207 obtains first code 211, the code may be entered into license distribution device 203. First code 211 may be, for example, manually entered into license distribution device 203 via a user input interface. License distribution device 203 may decode first code 211 and retrieve data that is embedded in first code 211. License distribution device 203 may store a randomly generated encryption table that functions as a certificate. The encryption table itself may be encrypted and may be unique to license distribution device 203 (e.g., if there are multiple license distribution devices, each license distribution device may have its own unique encryption table). License manager device 201 that is bound to license distribution device 203 and licensee device 205 that is paired with license distribution device may also each store an identical copy of the encryption table. The encryption table may be, for example, 32 kilobytes or 64 kilobytes in size. The encryption table may include multiple entries of decoding keys used to decode codes that are exchanged among license manager device 201, license distribution device 203, and licensee device 205. License distribution device 203 may use the encryption table to decode first code 211.

License distribution device 203 may keep track of licenses that the device is authorized to disburse. For example, license distribution device 203 may store blocks of licenses that are obtained (e.g., purchased) from license manager device 201 via first code 211. License distribution device 203 may store a counter that keeps track of how many licenses that license distribution device 203 is currently authorized to give out. Thus, for example, when additional licenses are purchased and first code 211 is entered into license distribution device 203, the counter may be increased by the quantity of purchased licenses. Conversely, when a certain quantity of licenses are disbursed by the license distribution device 203 (e.g., as when license distribution device 203 issues third code 215), then the counter may be decreased by the quantity of licenses that were disbursed.

Licensee device 205 may be software and/or hardware that consumes licenses issued by license manager device 201. For example, licensee device 205 may be CAD/CAM software and/or hardware that is authorized to manufacture a product on a per-license basis. In other words, in order for licensee device 205 to manufacture 150 items, the device may require at least 150 licenses to perform the task. Operator 209 may be a human end user who operates licensee device 205. Operator 209 may or may not be the same person as license purchaser 207. When operator 209 attempts to use licensee device 205 to perform a task (e.g., manufacture items), license device 205 may generate second code 213. Second code 213 may be a request for licenses. Second code 213 may be similar to first code 211 as described above. For example, second code 213 may be encrypted and include information indicating an identifier, a pairing code, a requested quantity of licenses, an error detection code, etc. Licensee device 205 may present second code 213 to operator 209 via, for example, a display, a speaker, etc.

After operator 209 obtains second code 213, the code may be entered into license distribution device 203. Second code 213 may be, for example, manually entered into license distribution device 203 via a user input interface. Alternatively, second code 213 may be sent by licensee device 205 to license distribution device 203 via a communication channel. License distribution device 203 may decode second code 213 and retrieve data that is embedded in second code 213. License distribution device 203 may use the encryption table to decode second code 213. License distribution device 203 may determine whether the device is storing enough licenses to fulfill the request for licenses as indicated in second code 213. If a requested quantity of licenses does not exceed the quantity of licenses that license distribution device 203 is authorized to disburse (e.g., as indicated by the counter), then license distribution device 203 may generate and issue third code 215. If, however, the requested quantity of licenses exceeds the quantity of licenses that license distribution device 203 is authorized to disburse, license distribution device 203 may refuse to issue third code 215 and output an appropriate error message instead.

Third code 215 may be similar to first code 211 as described above. For example, third code 215 may be encrypted and include information indicating an identifier, a pairing code, a quantity of licenses, an error detection code, etc. License distribution device 203 may present third code 215 to operator 209 via, for example, a display, a speaker, etc. The quantity of licenses indicated by third code 215 may coincide with the quantity of licenses indicated by second code 213. License distribution device 203 may not generate the same code twice to prevent replay attack (e.g., reuse of codes). License distribution device 203 may decrease its counter by the quantity of licenses that were requested by and disbursed to licensee device 205. The decreasing of the counter may take place before, after, or substantially at the same time as the generation of third code 215. For example, license distribution device 203 may decrease the counter and generate third code 215 atomically such that one could never happen without the other also happening even under unexpected circumstances (e.g., a sudden power loss, a device malfunction, a system crash, etc.).

After operator 209 obtains third code 215, the code may be entered into licensee device 205. Third code 215 may be, for example, manually entered into licensee device 205 via a user input interface. Alternatively, third code 215 may be sent by license distribution device 203 to licensee device 205 via a communication channel. Licensee device 205 may decode third code 215 and retrieve data that is embedded in third code 215. Licensee device 205 may use the encryption table to decode third code 215. Licensee device 205 may use the licenses that are embedded in third code 215 to perform a task (e.g., manufacture products).

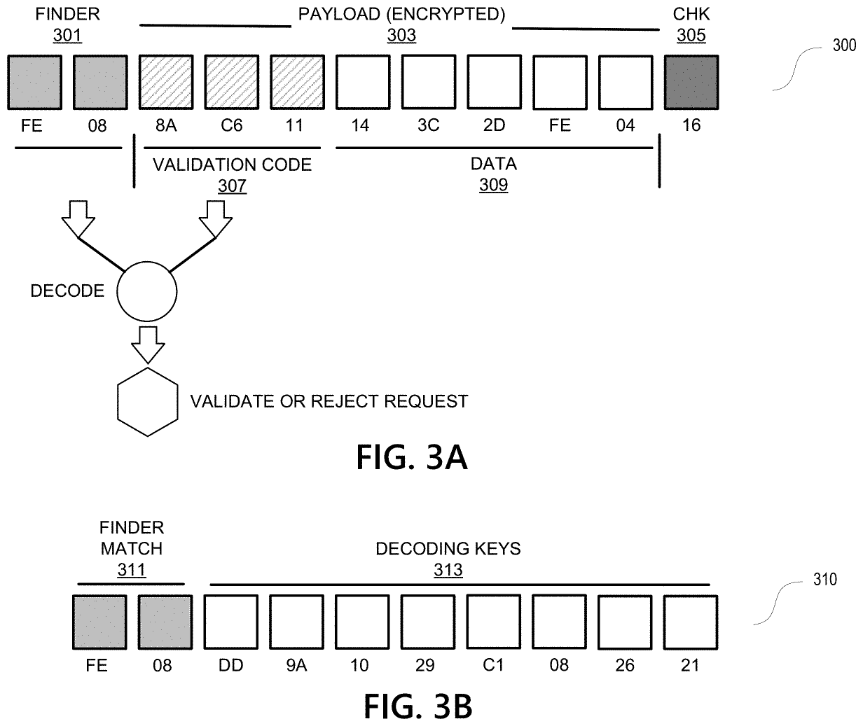

FIG. 3A depicts an example code that is generated in a license management system. Code 300 may be first code 211, second code 213, or third code 215 as described with respect to FIG. 2. Code 300 may have a variable length. Code 300 may include finder code 301, data payload 303 (also referred to as a data block), and error detection code 305 of variable lengths. The sizes and locations of these components within code 300 as well as the order in which they appear in may be kept secret to prevent unauthorized use and tampering. Code 300 in FIG. 3A is represented as a hexadecimal value, but code 300 may be any human-readable alphanumeric string.

Finder 301 may be of any size and located anywhere within code 300 and be used as an index for looking up decoding keys in an encryption table to decode payload 303. For example, finder code 301 may be the first two bytes (e.g., 0xFE08) of code 300. In another example, finder code 301 may be second, fifth, and eighth bytes of code 300.

Data payload 303 may be of any size and located anywhere within code 300. Data payload 303 may be encoded and/or encrypted to prevent unauthorized use and tampering. Data payload 303 may include validation code 307 and other data 309. Validation code 307 may be, for example, a binding code or a pairing code. Validation code 307 (e.g., a binding code, a pairing code, etc.) may be of a predetermined size and located at predetermined locations within code 300. For example, validation code 307 may be the first three bytes (e.g., 0x8AC611) of payload 303, but validation code 307 can be of any length and located anywhere within code 300. Other data 309 may include information indicating, for example, a license quantity, expiration date(s), an identifier (e.g., an identifier of license manager device 201, license distribution device 203, or licensee device 205), etc.

Error detection code 305 may be of any size and located anywhere within code 300. When code 300 is generated, error detection code 305 may be calculated, based on the rest code 300, and appended to code 300 to protect the integrity of code 300 and prevent tampering. For example, a device that receive code 300 may use error detection code 305 to detect any single-bit or multiple-bit error within code 300. Code 300 that is found to contain an error may be rejected and discarded by the receiving device. Error detection code 305 may be a checksum but any other error detection algorithm may be used.

A device that receives code 300 may verify it by decoding finder code 301 and validation code 307 using an encryption table. Once decoded, validation code 307 may be compared to a known binding code of a bound device or a known pairing code of a paired device. If a match is found, code 300 may be validated. If no match is found, code 300 may be considered invalid and the request embedded in code 300 may be rejected. Code 300 may include additional salt and/or utilize table offsetting schemes to further obfuscate its data content.

FIG. 3B depicts an example encryption table entry. An encryption table may be stored in license manager device, 201, license distribution device 203, and/or licensee device 205. The encryption table may include multiple entries such as encryption table entry 310. The entries may be non-duplicative (e.g., no two entries are the same) and/or arranged randomly (e.g., not arranged in any specific order) within the table. The encryption table may be, for example, 32 kilobytes, 64 kilobytes, etc. in size. The entire encryption table may be encrypted for an extra layer of protection and security. Encryption table entry 310 may include finder code 311 and decoding keys 313. Encryption table entry 310 and its components may have variable lengths and be arranged in any order.

Finder code 311 in encryption table entry 310 may have the same size as finder code 301 included in code 300. A device (e.g., license distribution device 203, licensee device 205, etc.) that is trying to decode code 300 may look up its encryption table to identify entry 310 with matching finder code 311 (e.g., 0xFE08) that matches finder code 301 (e.g., 0xFE08) from code 300. The device may then retrieve decoding keys 313 from encryption table entry 310 and apply it to data payload 303 of code 300 to obtain decoded data. For example, decoding keys 0xDD9A10 may be applied to validation code 307 of code 300 to obtain the decoded binding code. Applying decoding keys 313 to data 303 may involve, for example, XORing, but other methods may be used. For example, decoding keys 313 may be used as a secret key for decrypting data 303 in accordance with one or more encryption/decryption algorithms.

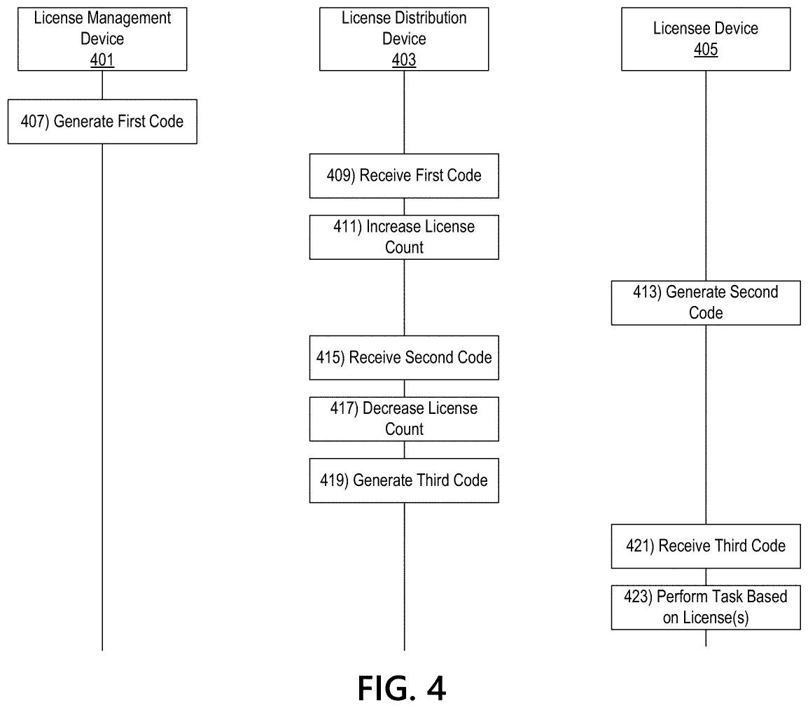

FIG. 4 depicts an example system flow diagram that illustrates a method of distributing one or more license tokens without the use of a network. The steps in this flow diagram need not all be performed in the order specified and some steps may be omitted or changed in order. License management device 401, license distribution device 403, and licensee device 405 may respectively correspond to license management device 201, license distribution device 203, and licensee device 205 of FIG. 2. License management device 401, license distribution device, 403, and licensee device 405 may each be communicatively disconnected (e.g., isolated) from each other. For example, the devices may lack wireless connections (e.g., Wi-Fi, Bluetooth, Zigbee, Infrared Data Association (IrDA), cellular network, etc.) and wired connections (e.g., Universal Serial Bus (USB), IEEE 1394, etc.) to each other. Alternatively, a communication channel may be established between license distribution device 403 and licensee device 405.

At step 407, license management device 401 may generate a first code. The first code may include information that authorizes a device such as license distribution device 405 to distribute a first quantity of licenses. The first code may be encoded and/or encrypted by license management device 401 using an encryption table. The first code may also include a validation code such as a binding code that binds license distribution device 403 to license management device 401. The first code may include identifier(s) of license management device 401 and/or license distribution device 403. The first code may include expiration date(s), after which the licenses would be no longer valid. The first code may include an error detection code. License management device 401 may output (e.g., display) the first code after generating the code for a user.

At step 409, license distribution device 403 may receive the first code. For example, the first code may be manually entered by a user (e.g., a license purchaser) to license distribution device 403 via a user interface such as a keyboard, a keypad, a touchpad, a touchscreen, a microphone, a button, etc. License distribution device 403 may decode and/or decrypt the first code using, for example, an encryption table. License distribution device 403 may reject and/or discard the first code if the validation code (e.g., a binding code) included in the first code does not match a predetermined validation code and/or if the error detection code indicates that the integrity of the first code has been compromised.

At step 411, license distribution device may increase a license count of license distribution device 403. The license count may be a total number of licenses that license distribution device 403 is authorized to distribute to other devices such as licensee device 405. The license count may be increased by a quantity of licenses as indicated by the first code. The license count may be represented as a counter or one or more license tokens stored in license distribution device 403. For example, if the first code indicated that 200 new licenses were to be added to license distribution device 403, then license distribution device 403 may increase its license counter by 200 and/or create 200 new license tokens in license distribution device 403.

At step 413, licensee device 405 may generate a second code for requesting a second quantity of licenses. The generation of the second quantity may be triggered by a user entering a command for licensee device 405 to perform a task such as manufacturing one or more products. For example, the second code may be generated when a user tries to manufacture a product in accordance with a CAD design. Performing the task may require one or more licenses. The second code may be encoded and/or encrypted by licensee device 405 using an encryption table and include information indicating a second quantity of licenses (e.g., how many licenses are being requested), a validation code (e.g., a pairing code), an identifier (e.g., an identifier of licensee device 405 and/or license distribution device 403), an error detection code, etc. Licensee device 405 may output (e.g., display) the second code to a user (e.g., an operator of licensee device 405).

At step 415, license distribution device 403 may receive the second code. For example, the second code may be manually entered by a user (e.g., an operator) to license distribution device 403 via a user interface such as a keyboard, a keypad, a touchpad, a touchscreen, a microphone, a button, etc. Alternatively, second code 213 may be sent by licensee device 205 to license distribution device 203 via a communication channel. License distribution device 403 may decode and/or decrypt the second code using, for example, an encryption table. License distribution device 403 may reject and/or discard the second code if the validation code (e.g., a pairing code) included in the second code does not match a predetermined validation code and/or if the error detection code indicates that the integrity of the second code has been compromised. License distribution device 403 may also reject and/or discard the second code if the requested quantity of licenses, as indicated in the second code, exceed the quantity of licenses that license distribution device is currently authorized to distribute (e.g., as indicated by the license counter).

At step 417, license distribution device 403 may decrease a license count. For example, distribution device 403 may decrease a license counter by the second quantity and/or delete the second quantity of license tokens stored in license distribution device. At step 419, license distribution device 403 may generate a third code that grants licensee device 405 the second quantity of licenses. Step 417 and step 419 may be performed substantially at the same time (e.g., atomically). The third code may be encoded and/or encrypted by license distribution device 403 using an encryption table and include information indicating the second quantity of licenses (e.g., how many licenses are being granted), a validation code (e.g., a pairing code), expiration date(s), an error detection code, etc. License distribution device 403 may output (e.g., display) the third code to a user (e.g., an operator of licensee device 405).

At step 421, licensee device 405 may receive the third code. For example, the third code may be manually entered by a user (e.g., an operator) to licensee device 405 via a user interface such as a keyboard, a keypad, a touchpad, a touchscreen, a microphone, a button, etc. Alternatively, the third code may be sent by license distribution device 403 to licensee device 405 via a communication channel. Licensee distribution device 405 may decode and/or decrypt the third code using, for example, an encryption table. Licensee device 405 may reject and/or discard the third code if the validation code (e.g., a pairing code) included in the third code does not match a predetermined validation code and/or if the error detection code indicates that the integrity of the third code has been compromised. At step 423, licensee device 405 may perform the task for which the licenses were sought. For example, licensee device 405 may consume the licenses received via the third code by preparing (e.g., manufacturing) one or more products. The task may be, for example, displaying data, printing, 3D printing, permitting use of software and/or hardware functionality, manufacturing, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving, by a license distribution device and via a first user input, a first code comprising a validation code and an indication of a first quantity of licenses, wherein the first code is generated by a license manager device, and wherein the license distribution device is communicatively disconnected from the license manager device when the first code is received by the license distribution device;
increasing, based on a determination that the validation code in the first code matches a predetermined validation code stored in the license distribution device, a license counter of the license distribution device by the first quantity of licenses;
receiving a second code comprising a request for a second quantity of licenses;
generating, based on the second code, a third code comprising an indication of the second quantity of licenses;
decreasing, based on the second code, the license counter of the license distribution device by the second quantity of licenses; and
causing output of the third code, wherein the third code is operable to enable a licensee device to prepare one or more products corresponding to the second quantity of licenses.

2. The method of claim 1, wherein the generating the third code and the decreasing the license counter are performed atomically.

3. The method of claim 1, wherein the license distribution device comprises a display, and wherein the causing the output of the third code comprises displaying, via the display of the license distribution device, the third code.

4. The method of claim 1, wherein the second code comprises an identifier associated with the licensee device, and wherein the generating the third code comprises generating the third code further based on the identifier.

5. The method of claim 1, wherein the license distribution device stores an encryption table, and wherein the receiving the first code comprises decrypt the first code using the encryption table.

6. The method of claim 5, wherein the license manager device stores the encryption table, and wherein the first code is encrypted by the license manager device using the encryption table.

7. The method of claim 1, wherein the second code is generated and encrypted by the licensee device, wherein the receiving the second code comprises receiving the second code via a second user input while the license distribution device is communicatively disconnected from the licensee device.

8. The method of claim 1, further comprising:
establishing a communication channel between the license distribution device and the licensee device,
wherein the receiving the second code comprises receiving the second code via the communication channel.

9. A license distribution device comprising:
a user input interface;
a display;
one or more processors; and
memory storing instructions that, when executed by the one or more processors, cause the license distribution device to:
receive, via the user input interface, a first code comprising a validation code and an indication of a first quantity of licenses, wherein the first code is generated by a license manager device, and wherein the license distribution device is communicatively disconnected from the license manager device when the first code is received by the license distribution device;
increase, based on a determination that the validation code in the first code matches a predetermined validation code stored in the license distribution device, a license counter of the license distribution device by the first quantity of licenses;
receive a second code comprising a request for a second quantity of licenses;
generate, based on the second code, a third code indicating the second quantity of licenses;
decrease, based on the second code, the license counter by the second quantity of licenses; and
output, via the display, of the third code, wherein the third code is operable to enable a licensee device to prepare one or more products corresponding to the second quantity of licenses.

10. The license distribution device of claim 9, wherein the user input interface comprise at least one of a keypad, a keyboard, a touchscreen, a touchpad, a microphone, or a button.

11. The license distribution device of claim 9, wherein the instructions, when executed by the one or more processors, cause the license distribution device to atomically generate the third code and delete the second quantity of licenses.

12. The license distribution device of claim 9, wherein the instructions, when executed by the one or more processors, further cause the license distribution device to:
store an encryption table; and
decrypt the first code using the encryption table.

13. The license distribution device of claim 9, wherein the second code is generated and encrypted by the licensee device, and
wherein the instructions, when executed by the one or more processors, cause the license distribution device to receive the second code via the user input interface while the license distribution device is communicatively disconnected from the licensee device.

14. The license distribution device of claim 9, wherein the instructions, when executed by the one or more processors, further cause the license distribution device to establish a communication channel between the license distribution device and the licensee device, and
wherein the instructions, when executed by the one or more processors, cause the license distribution device to receive the second code via the communication channel.

15. A system comprising:
a license management device configured to:
generate a first code comprising a first quantity of licenses; and
output the first code;
a license distribution device configured to:
receive, via a first user input, the first code while the license distribution device is communicatively disconnected from the license manager device;
store, based on the first code, the first quantity of licenses;
receive a second code;
generate, based on the second code, a third code comprising a second quantity of licenses; and
output the third code; and
a licensee device configured to:
generate the second code;
output the second code;
receive the third code; and
prepare one or more products corresponding to the second quantity of licenses.

16. The system of claim 15, wherein the license distribution device is configured to receive the second code via a second user input while the license distribution device is communicatively disconnected from the licensee device,
wherein the license distribution device is configured to output the third code via a display for a user, and
wherein the licensee device is configured to receive the third code via a third user input while the licensee device is communicatively disconnected from the license distribution device.

17. The system of claim 15, wherein the license distribution device is further configured to establish a communication channel between the license distribution device and the licensee device,
wherein the distribution device is configured to receive the second code via the communication channel, and
wherein the licensee device is configured to receive the third code via the communication channel.

18. The system of claim 15, wherein the second code comprises an identifier associated with the licensee device, and wherein the license distribution device is configured to generate the third code further based on the identifier.

19. The system of claim 15, wherein the license distribution device is further configured to:
store an encryption table; and
decrypt the first code using the encryption table.

20. The system of claim 15, wherein the first code comprises a validation code, and the license distribution device is further configured to increase a license counter based on a determination that the validation code in the first code matches a predetermined validation code stored in the license distribution device.
